(19) United States
(12) Patent Application Publication
(10) Pub. No.: US 2025/0362066 A1
(43) Pub. Date: Nov. 27, 2025

(54) CHILLER PURGE SYSTEMS AND METHODS

(71) Applicant: Tyco Fire & Security GmbH, Neuhausen am Rheinfall (CH)

(72) Inventors: David Andrew Bradshaw, Timonium, MD (US); Jing Li, Red Lion, PA (US); Seth Kevin Gladfelter, Red Lion, PA (US); Jeb William Schreiber, Stewartstown, PA (US)

(21) Appl. No.: 18/872,237

(22) PCT Filed: Jun. 7, 2023
(86) PCT No.: PCT/US2023/024710

§ 371 Date: Dec. 5, 2024

Related U.S. Application Data
(60) Provisional application No. 63/349,916, filed on Jun. 7, 2022.

(51) Int. Cl. F25B 43/04; F25B 41/20; F25B 45/00; F25B 49/02

(52) U.S. Cl. CPC F25B 43/043; F25B 41/20; F25B 45/00; F25B 49/02; F25B 2345/002; F25B 2345/003; F25B 2700/04

(57) ABSTRACT

A purge system for a heating, ventilation, air conditioning, and refrigeration (HVAC&R) system includes a purge tank configured to receive a fluid mixture from a vapor compression system. The fluid mixture includes heat transfer fluid, non-condensable gases, and condensable fluid. The purge system includes a valve system fluidly coupled to the purge tank and a controller communicatively coupled to the valve system. The controller is configured to adjust the valve system based on feedback to selectively discharge the heat transfer fluid from the purge tank, to selectively discharge the non-condensable gases from the purge tank, and to selectively discharge the condensable fluid from the purge tank.

### CROSS-REFERENCE TO RELATED APPLICATIONS

This application claims priority from and the benefit of U.S. Provisional Application No. 63/349,916, entitled “CHILLER PURGE SYSTEMS AND METHODS,” filed Jun. 7, 2022, which is herein incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A chiller system for applications in residential, commercial, or industrial heating, ventilation, air conditioning, and/or refrigeration (HVAC&R) systems typically includes a compressor for circulating a working fluid (e.g., refrigerant) through heat exchangers of the HVAC&R system. The heat exchangers facilitate transfer of thermal energy between the working fluid and a space to be conditioned, such as a room or zone within a building or other structure serviced by the HVAC&R system. The compressor and the heat exchangers form a portion of a vapor compression system of the HVAC&R system. In some cases (e.g., when using low pressure refrigerant), non-condensable gases (e.g., air, nitrogen) and/or condensable fluid (e.g., water) may accumulate in the vapor compression system and mix with the refrigerant. Unfortunately, accumulation of such impurities in the vapor compression system may decrease an overall operational efficiency of the HVAC&R system.

### SUMMARY

The present disclosure relates to a purge system for a heating, ventilation, air conditioning, and refrigeration (HVAC&R) system. The purge system includes a purge tank configured to receive a fluid mixture from a vapor compression system. The fluid mixture includes heat transfer fluid, non-condensable gases, and condensable fluid. The purge system includes a valve system fluidly coupled to the purge tank and a controller communicatively coupled to the valve system. The controller is configured to adjust the valve system based on feedback to selectively discharge the heat transfer fluid from the purge tank, to selectively discharge the non-condensable gases from the purge tank, and to selectively discharge the condensable fluid from the purge tank.

The present disclosure also relates to a float system for a purge tank of a heating, ventilation, air conditioning, and refrigeration (HVAC&R) system. The float system includes a plurality of switches and a plurality of floats configured to move relative to the plurality of switches. The plurality of switches and the plurality of floats are configured to be disposed within the purge tank. The plurality of floats is configured to selectively engage one or more switches of the plurality of switches based on a first amount of condensable fluid within the purge tank and a second amount of heat transfer fluid within the purge tank to generate one or more signals indicative of the first amount and the second amount.

The present disclosure also relates to a purge system for a heating, ventilation, air conditioning, and refrigeration (HVAC&R) system. The purge system includes a float system configured to be disposed within a purge tank. The float system includes a plurality of switches and a plurality of floats configured to selectively engage, based on a first amount of condensable fluid within the purge tank and a second amount of heat transfer fluid within the purge tank, one or more switches of the plurality of switches to generate one or more signals. The purge system also includes a controller configured to receive the one or more signals and to analyze the one or more signals to determine the first amount of the condensable fluid within the purge tank, the second amount of the heat transfer fluid within the purge tank, or both.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building utilizing a heating, ventilating, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of the vapor compression system of FIG. 2, in accordance with an aspect of the present disclosure;

FIG. 4 is a schematic of an embodiment of the vapor compression system of FIG. 2, in accordance with an aspect of the present disclosure;

FIG. 5 is a schematic of an embodiment of a vapor compression system having a purge system, in accordance with an aspect of the present disclosure;

FIG. 6 is a schematic of an embodiment of a portion of a purge tank of a purge system, in accordance with an aspect of the present disclosure;

FIG. 7 is a schematic of an embodiment of a portion of a purge tank of a purge system, in accordance with an aspect of the present disclosure;

FIG. 8 is a schematic of an embodiment of a portion of a purge tank of a purge system, in accordance with an aspect of the present disclosure;

FIG. 9 is a schematic of an embodiment of a portion of a purge tank of a purge system, in accordance with an aspect of the present disclosure;

FIG. 10 is a cross-sectional schematic side view of an embodiment of a condenser of a vapor compression system, in accordance with an aspect of the present disclosure; and

FIG. 11 is a cross-sectional schematic axial view of an embodiment of an evaporator of a vapor compression system, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

As briefly discussed above, a heating, ventilation, air conditioning, and/or refrigeration (HVAC&R) system may be used to thermally regulate a space within a building, home, or other suitable structure. For example, the HVAC&R system may include a vapor compression system (e.g., a chiller system) that transfers thermal energy between a heat transfer fluid (e.g., a working fluid), such as a refrigerant, and a fluid to be conditioned, such as air, water, or brine. The vapor compression system may include a condenser and an evaporator that are fluidly coupled to one another via one or more conduits. A compressor may be used to circulate the heat transfer fluid through the conduits and, thus, enable the transfer of thermal energy between the heat transfer fluid and the fluid to be conditioned via the condenser and/or the evaporator.

In some cases, operation of the HVAC&R system may result in the accumulation of non-condensable gases (e.g., air, nitrogen) and/or condensable fluid (e.g., water) within components (e.g., heat exchangers, conduits) of the vapor compression system. For example, during operation of the HVAC&R system, a pressure within certain components of the HVAC&R system may fall below zero PSIG (pounds per square inch gauge). That is, under operational conditions of these components, the pressure within the components may be less than the surrounding atmospheric pressure. This pressure differential may introduce (e.g., force) impurities (e.g., non-condensable gases, condensable fluid) from the atmosphere into the components of the vapor compression system over time. As a result, such impurities may mix with the heat transfer fluid within the vapor compression system. Unfortunately, mixing of non-condensable gases and/or water with the heat transfer fluid of the vapor compression system may decrease an overall operational efficiency of the vapor compression system.

Accordingly, embodiments of the present disclosure are directed toward a purge system that is configured to facilitate removal (e.g., purging) of non-condensable gases and condensable fluid (e.g., water) from the vapor compression system to improve a purity of the heat transfer fluid within the vapor compression system and enhance an overall operational efficiency of the HVAC&R system. The purge system may include a purge tank that is fluidly coupled to the condenser and/or the evaporator via corresponding conduits. The purge tank may be configured to selectively receive a mixture (e.g., a fluid mixture) of heat transfer fluid (e.g., refrigerant) and non-condensable gases from the condenser. The purge tank may include a purge coil that is configured to reduce a temperature within the purge tank. As such, the purge coil may enable heat transfer fluid (e.g., gaseous heat transfer fluid) entering the purge tank (e.g., from the condenser) to condense into a liquid phase or state, while the non-condensable gases received from the condenser may remain in a gaseous phase or state. Condensed heat transfer fluid within the purge tank may flow toward a collection basin of the purge tank, which may be positioned vertically below (e.g., with respect to a direction of gravity) at least a portion of the purge coil. A vent of the purge system may enable discharge of the non-condensable gases from the purge tank to an ambient environment, such as the atmosphere. A drain of the purge system may enable discharge of heat transfer fluid from the collection basin back toward a component (e.g., the evaporator) of the vapor compression system. In this way, the purge tank facilitates purging (e.g., removal) of non-condensable gases from the heat transfer fluid of the vapor compression system.

The purge tank may also be configured to selectively receive a mixture (e.g., a fluid mixture) of heat transfer fluid (e.g., refrigerant) and condensable fluid (e.g., moisture, water vapor) from the evaporator (and/or from another component of the vapor compression system). The purge coil facilitates condensation of the heat transfer fluid and the condensable fluid within the purge tank. Accordingly, operation of the purge coil enables accumulation of liquid heat transfer fluid and the condensable fluid (e.g., liquid water) within the collection basin. A density of the condensable fluid in the collection basin may be less than a density of the liquid heat transfer fluid in the collection basin. Accordingly, the condensable fluid and the liquid heat transfer fluid may be stratified within the collection basin. That is, the condensable fluid may accumulate above, with respect to a direction of gravity, the liquid heat transfer fluid accumulated within the collection basin. The purge system may include a float assembly that is configured to provide feedback (e.g., data) indicative of an amount of heat transfer fluid in the purge tank, an amount of condensable fluid in the purge tank, or both. A controller of the purge system may receive the feedback and be configured to operate components (e.g., one or more valves) of the purge system based on the feedback to selectively drain the heat transfer fluid, the condensable fluid, or both, from the collection basin of the purge tank. To this end, the purge tank facilitates purging (e.g., removal) of condensable fluid from the heat transfer fluid of the vapor compression system. These and other features will be described in detail below with reference to the drawings.

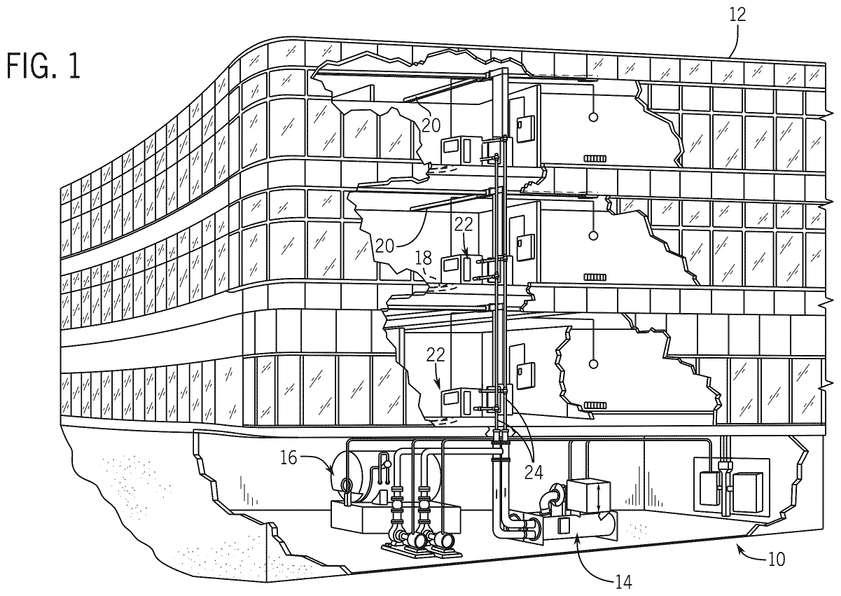

Turning now to the drawings, FIG. 1 is a perspective view of an embodiment of an environment for a heating, ventilation, air conditioning, and refrigeration (HVAC&R) system 10 in a building 12 for a typical commercial setting. The HVAC&R system 10 may include a vapor compression system 14 (e.g., a chiller system) that supplies a chilled liquid, which may be used to cool the building 12. The HVAC&R system 10 may also include a boiler 16 to supply warm liquid to heat the building 12 and an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or chilled liquid from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

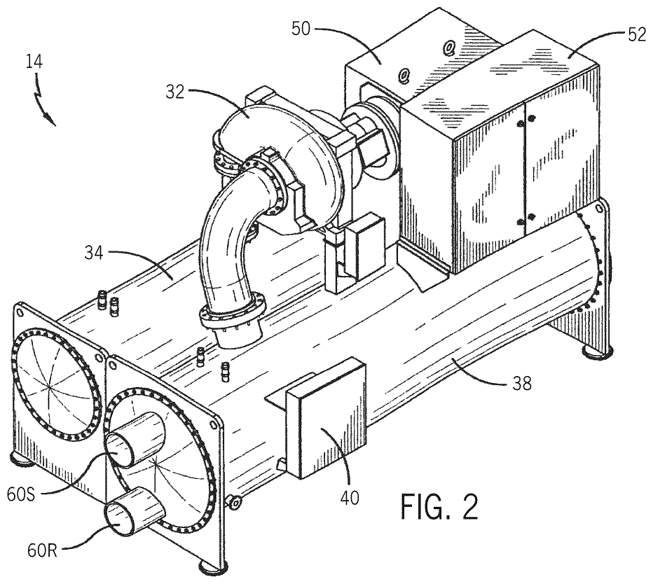

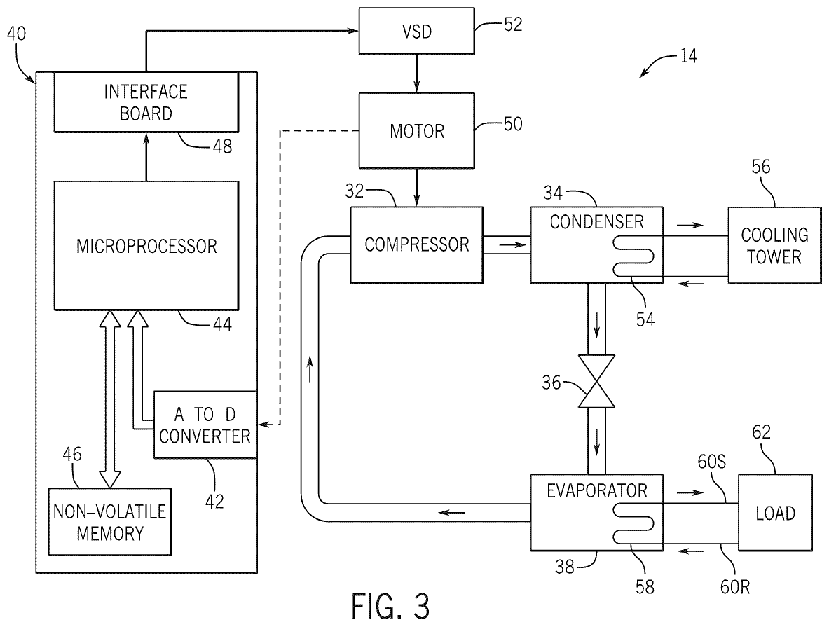

FIGS. 2 and 3 are embodiments of the vapor compression system 14 that can be used in the HVAC&R system 10. The vapor compression system 14 may circulate a heat transfer fluid through a circuit starting with a compressor 32. The circuit may also include a condenser 34, an expansion valve(s) or device(s) 36, and a liquid chiller or an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as heat transfer fluids (e.g., refrigerants) in the vapor compression system 14 are hydrofluorocarbon (HFC) based refrigerants, for example, R-410A, R-407, R-134a, hydrofluoro olefin (HFO), “natural” refrigerants like ammonia (NH₃), R-717, carbon dioxide (CO₂), R-744, or hydrocarbon-based refrigerants, water vapor, or any other suitable refrigerant. In some embodiments, the vapor compression system 14 may be configured to efficiently utilize heat transfer fluids having a normal boiling point of about 19 degrees Celsius (66 degrees Fahrenheit) at one atmosphere of pressure, also referred to as low pressure refrigerants, versus a medium pressure refrigerant, such as R-134a. For example, the vapor compression system 14 may utilize R1233zd as a heat transfer fluid. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 and may be powered by the variable speed drive (VSD) 52. The VSD 52 receives alternating current (AC) power having a particular fixed line voltage and fixed line frequency from an AC power source and provides power having a variable voltage and frequency to the motor 50. In other embodiments, the motor 50 may be powered directly from an AC or direct current (DC) power source. The motor 50 may include any type of motor that can be powered by a VSD or directly from an AC or DC power source, such as a switched reluctance motor, an induction motor, an electronically commutated permanent magnet motor, or another suitable motor.

The compressor 32 compresses a heat transfer fluid vapor and delivers the vapor to the condenser 34 through a discharge passage. In some embodiments, the compressor 32 may be a centrifugal compressor. The heat transfer fluid vapor delivered by the compressor 32 to the condenser 34 may transfer heat to a cooling fluid (e.g., water or air) in the condenser 34. The heat transfer fluid vapor may condense to a heat transfer fluid liquid in the condenser 34 as a result of thermal heat transfer with the cooling fluid. The liquid heat transfer fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser 34.

The liquid heat transfer fluid delivered to the evaporator 38 may absorb heat from another cooling fluid, which may or may not be the same cooling fluid used in the condenser 34. The liquid heat transfer fluid in the evaporator 38 may undergo a phase change from the liquid heat transfer fluid to a heat transfer fluid vapor. As shown in the illustrated embodiment of FIG. 3, the evaporator 38 may include a tube bundle 58 having a supply line 60S and a return line 60R connected to a cooling load 62. The cooling fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the cooling fluid in the tube bundle 58 via thermal heat transfer with the heat transfer fluid. The tube bundle 58 in the evaporator 38 can include a plurality of tubes and/or a plurality of tube bundles. In any case, the vapor heat transfer fluid exits the evaporator 38 and returns to the compressor 32 by a suction line to complete the cycle.

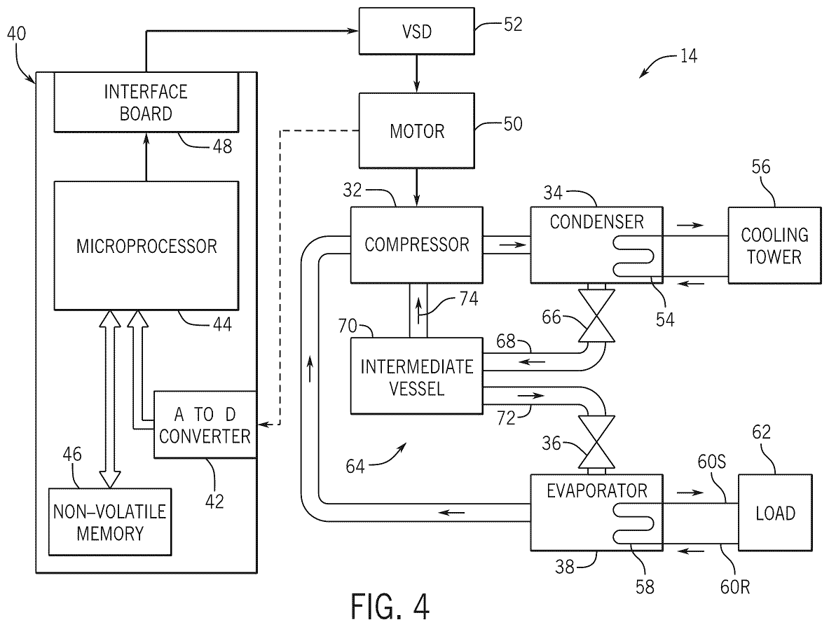

FIG. 4 is a schematic of the vapor compression system 14 with an intermediate circuit 64 incorporated between condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid heat transfer fluid received from the condenser 34. During the expansion process, a portion of the liquid may vaporize, and thus, the intermediate vessel 70 may be used to separate the vapor from the liquid received from the first expansion device 66.

Additionally, the intermediate vessel 70 may provide for further expansion of the liquid heat transfer fluid because of a pressure drop experienced by the liquid heat transfer fluid when entering the intermediate vessel 70 (e.g., due to a rapid increase in volume experienced when entering the intermediate vessel 70). The vapor in the intermediate vessel 70 may be drawn by the compressor 32 through a suction line 74 of the compressor 32. In other embodiments, the vapor in the intermediate vessel may be drawn to an intermediate stage of the compressor 32 (e.g., not the suction stage). The liquid that collects in the intermediate vessel 70 may be at a lower enthalpy than the liquid refrigerant exiting the condenser 34 due to expansion in the expansion device 66 and/or the intermediate vessel 70. The liquid from intermediate vessel 70 may then flow in line 72 through a second expansion device 36 to the evaporator 38.

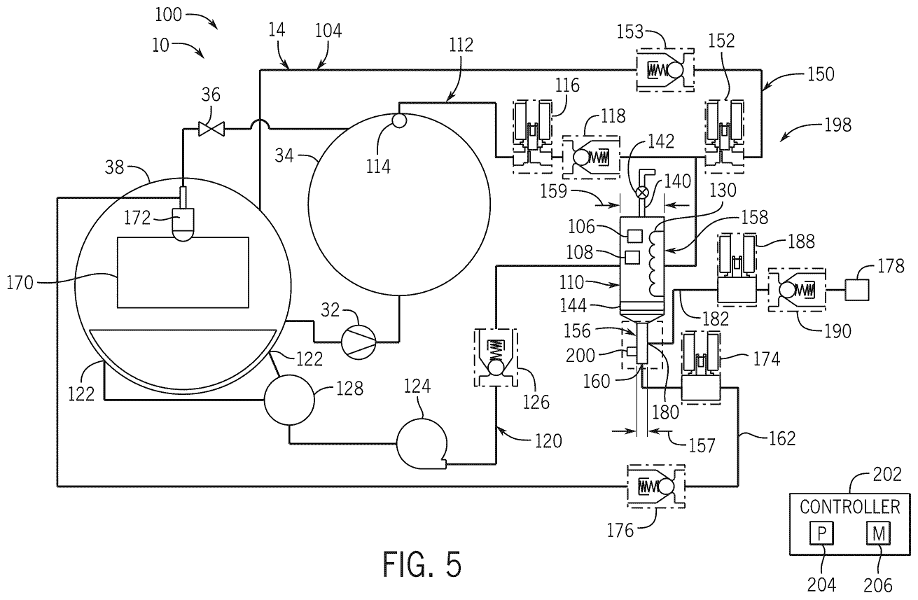

With the foregoing in mind, FIG. 5 is a schematic diagram of an embodiment of a portion of the HVAC&R system 10 that includes a purge system 100 configured to purge impurities (e.g., non-condensable gases, condensable fluid) from the heat transfer fluid (e.g., R1233zd) of the vapor compression system 14. The vapor compression system 14 includes a plurality of conduits configured to fluidly couple components (e.g., the evaporator 38, the condenser 34, the compressor 32, the expansion device 36) of the vapor compression system 14 to one another to form a heat transfer fluid circuit 104 (e.g., working fluid circuit). In some embodiments, operation of the HVAC&R system 10 may cause a pressure within at least a portion (e.g., the evaporator 38) of the heat transfer fluid circuit 104 to decrease below an ambient atmospheric pressure (e.g., less than 14.7 pounds per square inch [PSI]; less than zero PSIG). As a result, a pressure differential may be created between the heat transfer fluid circuit 104 (e.g., components of the refrigerant circuit 104) and an ambient environment (e.g., an environment surrounding the vapor compression system 14). In some embodiments, the pressure differential may cause non-condensable gases 106 (e.g., air, nitrogen) from the ambient environment to enter components (e.g., conduits, heat exchangers) of the vapor compression system 14 and mix with the heat transfer fluid within the heat transfer fluid circuit 104. The non-condensable gases 106 may include any gases (e.g., air, nitrogen) that are not condensable at operating temperatures of the vapor compression system 14 (e.g., normal operating temperatures of the vapor compression system 14 that are not achieved in a laboratory setting). The non-condensable gases 106 may be circulated through the heat transfer fluid circuit 104 via the compressor 32 and may accumulate in the condenser 34, which may ultimately reduce the operating efficiency of the vapor compression system 14, the compressor 32, the condenser 34, the evaporator 38, other components of the HVAC&R system 10, or any combination thereof.

In certain embodiments, the pressure differential between certain components (e.g., the evaporator 38) of the vapor compression system 14 and the ambient environment may also cause condensable fluid 108 (e.g., water, moisture, water vapor) to enter the heat transfer fluid circuit 104 (e.g., a component of the heat transfer fluid circuit 104) from the ambient environment. For example, in certain cases, air entering the heat transfer fluid circuit 104 may include moisture (e.g., water vapor) suspended therein, which may ultimately condense within one or more components (e.g., the evaporator 38) of the heat transfer fluid circuit 104 and may accumulate within the one or more components. Accumulation of water within the heat transfer fluid circuit 104 may reduce the operating efficiency of the vapor compression system 14, the compressor 32, the condenser 34, the evaporator 38, other components of the HVAC&R system 10, or any combination thereof, and may also increase a likelihood of corrosion or wear inside the heat transfer fluid circuit 104

The purge system 100 may be configured to remove and/or separate the non-condensable gases 106 and the condensable fluid 108 from the heat transfer fluid within the vapor compression system 14. In the illustrated embodiment, the purge system 100 includes a purge tank 110 that is fluidly coupled to the condenser 34 and the evaporator 38. For example, a first flow path 112 (e.g., one or more conduits) may fluidly couple the purge tank 110 to a first port 114 (e.g., one or more ports) of the condenser 34. The first port 114 may be located near an upper portion of the condenser 34, with respect to a direction of gravity, and may enable flow of heat transfer fluid and non-condensable gases 106 into the first flow path 112 and toward the purge tank 110. During certain operational periods or modes of the HVAC&R system 10, a pressure within the condenser 34 may be higher than a pressure within the purge tank 110. As such, the pressure differential between the condenser 34 and the purge tank 110 may be sufficient to enable flow of heat transfer fluid and non-condensable gases 106 (e.g., a fluid mixture) from the first port 114 to the purge tank 110 without utilization of a pump, for example. In other embodiments, a pump may be fluidly coupled to the first flow path 112 and configured to direct a flow of heat transfer fluid and non-condensable gases 106 from the condenser 34 to the purge tank 110.

In certain embodiments, a first control valve 116 may be disposed along (e.g., fluidly coupled to) the first flow path 112 and be configured to regulate (e.g., throttle) flow of heat transfer fluid and non-condensable gases 106 from the condenser 34 to the purge tank 110. A first check valve 118 may be disposed along the first flow path 112 and be configured to inhibit (e.g., block) fluid flow from the purge tank 110 to the condenser 34 via the first flow path 112.

In some embodiments, a second flow path 120 (e.g., one or more conduits) may fluidly couple the purge tank 110 to a second port 122 (e.g., one or more ports) of the evaporator 38. The second port 122 may be located near a lower portion of the evaporator 38, with respect to a direction of gravity, and may enable flow of heat transfer fluid and condensable fluid 108 (e.g., a fluid mixture) into the second flow path 120 and toward the purge tank 110. In some embodiments, a pump 124 (e.g., a control valve) may be disposed along the second flow path 120 and be configured to direct a flow of heat transfer fluid and condensable fluid 108 from the evaporator 38 to the purge tank 110. A second check valve 126 may be disposed along the second flow path 120 and be configured to inhibit (e.g., block) fluid flow from the purge tank 110 to the evaporator 38 via the second flow path 120. In some embodiments, a liquid tank 128 may be disposed along the second flow path 120 and be configured to accumulate liquid (e.g., the condensable fluid 108) that may be received from the second port 122 of the evaporator 38. In certain embodiments, the pump 124 may be disposed within or otherwise integrated with the liquid tank 128.

In some embodiments, the purge tank 110 may include a purge coil 130 that is configured to reduce a temperature within the purge tank 110 to facilitate condensation of heat transfer fluid and condensable fluid 108 in the purge tank 110. As discussed in detail herein, condensation of heat transfer fluid in the purge tank 110 may facilitate separation of the heat transfer fluid from the non-condensable gases 106 and the condensable fluid 108 that may be within the purge tank 110 and mixed with the heat transfer fluid upon entry into the purge tank 110. In some embodiments, the purge coil 130 may be coupled to an auxiliary cooling system that is configured to provide cooled purge heat transfer fluid (e.g., refrigerant) or other chilled fluid to the purge coil 130. As such, fluid circulating through the purge coil 130 may absorb thermal energy from fluid (e.g., a fluid mixture of heat transfer fluid, non-condensable gases 106, and/or condensable fluid 108) within the purge tank 110. In some embodiments, the fluid circulating through the purge coil 130 may be separate (e.g., isolated from) fluid circulating through the heat transfer fluid circuit 104. In other embodiments, the fluid circulating through the purge coil 130 may include heat transfer fluid received from a portion of the heat transfer fluid circuit 104 (e.g., heat transfer fluid received from the expansion device 36).

In any case, a gaseous mixture of heat transfer fluid and non-condensable gases 106 may flow from the condenser 34 of the vapor compression system 14 to the purge tank 110 via the first flow path 112. In some embodiments, the mixture of heat transfer fluid and non-condensable gases 106 may flow into the purge tank 110 via a thermal siphon. Additionally or alternatively, a partial vacuum may be created within the purge tank 110 (e.g., when the incoming heat transfer fluid condenses in the purge tank 110) and facilitate flow of fluid through the first flow path 112 into the purge tank 110. In certain embodiments, the pump 124 may direct heat transfer fluid and condensable fluid 108 from the evaporator 38 into the purge tank 110. In some embodiments, the pump 124 may include or be replaced with a control valve configured to regulate (e.g., throttle) flow of fluid along the second flow path 120 from the evaporator 38 to the purge tank 110. That is, such a control valve may rely on a pressure difference between the evaporator 38 and the purge tank 110 to adjust flow of fluid from the evaporator 38 to the purge tank 110 without usage of the pump 124 (e.g., such as when a pressure within the evaporator 38 is greater than a pressure within the purge tank 110). As such, the pump 124 may be omitted from the second flow path 120 in certain embodiments.

In some embodiments, the first control valve 116 may enable flow of heat transfer fluid and non-condensable gases 106 from the condenser 34 to the purge tank 110 at a first time and the pump 124 may operate at a second time (e.g., a time different from the first time) to direct heat transfer fluid and condensable fluid 108 from the evaporator 38 into the purge tank 110. In any case, the purge coil 130 may absorb heat (e.g., thermal energy) from the mixture of heat transfer fluid, non-condensable gases 106, and condensable fluid 108 that may be within the purge tank 110. As such, the heat transfer fluid and condensable fluid 108 within the purge tank 110 may condense into the liquid state and the non-condensable gases 106 may remain in the gaseous state.

In some embodiments, at least a portion of the purge coil 130 may be submerged in a mixture of heat transfer fluid and condensable fluid 108. The submerged portion of the purge coil 130 may facilitate subcooling of the heat transfer fluid and condensable fluid 108 and may thereby reduce or substantially inhibit heat transfer fluid flashing within the purge tank 110. Further, subcooling of the mixture of heat transfer fluid and condensable fluid 108 in the purge tank 110 may lower a solubility of water to heat transfer fluid in the purge tank 110, which may facilitate separation (e.g., stratification) of the heat transfer fluid and the condensable fluid 108 in the purge tank 110. An exposed portion of the purge coil 130 (e.g., a portion of the purge coil 130 that may not be submerged in a mixture of heat transfer fluid and condensable fluid 108) may facilitate separation of condensable gas in the purge tank 110 from the non-condensable gases 106.

The non-condensable gases 106 in the purge tank 110 may be discharged from the purge tank 110 (e.g., to the ambient environment, to an emission canister of the purge system 100) via a first outlet port 140 of the purge tank 110. A first outlet valve 142 (e.g., solenoid valve) may be coupled to the first outlet port 140 and be configured to regulate flow of the non-condensable gases 106 from the purge tank 110 to the ambient environment. A controller of the purge system 100 may operate the first outlet valve 142 (e.g., based on sensor feedback and/or control instructions) to selectively discharge the non-condensable gases 106 from the purge tank 110 to the ambient environment (e.g., via the first outlet port 140). In some embodiments, the purge tank 110 may include a heating element 144 that may be selectively activated to heat an interior of the purge tank 110, which may increase a pressure in the purge tank 110. The pressure increase in the purge tank 110 may facilitate flow of the non-condensable gases 106 through the first outlet port 140 and into the ambient environment.

In some embodiments, the purge system 100 may include an auxiliary flow path 150 that fluidly couples the evaporator 38 (or another component of the vapor compression system 14) to the purge tank 110. An auxiliary control valve 152 and an auxiliary check valve 153 may be disposed along the auxiliary flow path 150 and be configured to regulate a pressure differential between the purge tank 110 and the evaporator 38, for example. As such, the auxiliary control valve 152 and/or the auxiliary check valve 153 may ensure that the pressure within the purge tank 110 remains substantially within a target operating range. In some embodiments, the auxiliary check valve 153 may inhibit (e.g., block) fluid flow from evaporator 38 to the purge tank 110, such as when a pressure within the purge tank 110 is less than a pressure within the evaporator 38.

The liquid heat transfer fluid and the condensable fluid 108 within the purge tank 110 may accumulate within a collection basin 156 of the purge tank 110. The collection basin 156 may be positioned below (e.g., with respect to a direction of gravity) a remaining portion 158 (e.g., an upper portion) of the purge tank 110. A density of the heat transfer fluid within the collection basin 156 may be greater than a density of the condensable fluid 108 within the collection basin 156. As such, liquid heat transfer fluid in the collection basin 156 may accumulate below (e.g., with respect to a direction of gravity) any condensable fluid 108 that may be accumulated within the collection basin 156. In some embodiments, a first diameter 157 or cross-sectional area of the collection basin 156 may be less than a second diameter 159 or cross-sectional area of the remaining portion 158 of the purge tank 110. An axial dimension or axis of the collection basin 156, an axial dimension or axis of the remaining portion 158, or both, may extend generally along a direction of gravity. The relatively small first diameter 157 of the collection basin 156 (e.g., compared to the second diameter 159 of the remaining portion 158) may facilitate accumulation of an extended column of liquid within the collection basin 156, which may facilitate stratification (e.g., gravity-based stratification) of the liquid heat transfer fluid and the condensable fluid 108 that may be within the collection basin 156. As discussed below, stratification of the liquid heat transfer fluid and the condensable fluid 108 within the collection basin 156 may facilitate selective (e.g., independent) removal of the liquid heat transfer fluid or the condensable fluid 108 from the collection basin 156.

Liquid heat transfer fluid may be drained from the collection basin 156 to the evaporator 38 via a second outlet port 160 of the purge tank 110. The second outlet port 160 may be fluidly coupled to the evaporator 38 via a third flow path 162 (e.g., one or more conduits). In some embodiments, a pressure differential between the evaporator 38 and the purge tank 110 may be sufficient to induce flow of liquid heat transfer fluid from the collection basin 156 to the evaporator 38 along the third flow path 162. In other embodiments, a pump may be disposed along the third flow path 162 and be configured to direct the liquid heat transfer fluid from the collection basin 156 to the evaporator 38. Liquid heat transfer fluid received at the evaporator 38 via the third flow path 162 may be directed onto a plurality of tubes 170 of the evaporator 38 via a heat transfer fluid distributor 172. In some embodiments, a second outlet valve 174 may be disposed along the third flow path 162 and be configured to regulate (e.g., throttle) flow of heat transfer fluid from the collection basin 156 to the evaporator 38. A third check valve 176 may be disposed along the third flow path 162 and be configured to inhibit (e.g., block) fluid flow from the evaporator 38 to the purge tank 110 via the third flow path 162.

Condensable fluid 108 may be drained from the collection basin 156 to an environment 178 (e.g., a tank, the ambient environment) via a third outlet port 180 of the purge tank 110. The third outlet port 180 may be positioned vertically above the second outlet port 160 (e.g., with respect to a direction of gravity). The third outlet port 180 may be fluidly coupled to the environment 178 via a fourth flow path 182. In some embodiments, a pressure differential between the purge tank 110 and the environment 178 may be sufficient to induce flow of condensable fluid 108 from the collection basin 156 to the environment 178 along the fourth flow path 182. In other embodiments, a pump may be disposed along the fourth flow path 182 and be configured to direct the condensable fluid 108 from the collection basin 156 to the environment 178. In some embodiments, a third outlet valve 188 may be disposed along the fourth flow path 182 and be configured to regulate (e.g., throttle) flow of condensable fluid 108 from the collection basin 156 to the environment 178. A fourth check valve 190 may be disposed along the fourth flow path 182 and be configured to inhibit (e.g., block) fluid flow from the environment 178 to the purge tank 110 via the fourth flow path 182. The valves 116, 142, 152, 174, and/or 188 and/or the pump 124 (e.g., a control valve) may form at least a portion of a control valve system 198 (e.g., a valve system) of the purge system 100.

In some embodiments, a rate at which heat transfer fluid accumulates within the collection basin 156 over time may be greater than a rate at which condensable fluid 108 accumulates within the collection basin 156. As such, it may be desirable to determine quantities of the heat transfer fluid and the condensable fluid 108 within the collection basin 156 and to selectively discharge the heat transfer fluid to the evaporator 38, to selectively discharge the condensable fluid 108 to the environment 178, or both, based on the corresponding quantities of the heat transfer fluid and the condensable fluid 108 that may be within the collection basin 156. Accordingly, the purge tank 110 includes a float system 200 that, as discussed in detail herein, enables a controller 202 of the purge system 100 to determine a quantity of heat transfer fluid within the collection basin 156, to determine a quantity of condensable fluid 108 in the collection basin 156, or both.

The controller 202 (e.g., a control system, a control panel, an automation controller) may be communicatively coupled to one or more components of the HVAC&R system 10 and is configured to monitor, adjust, and/or otherwise control operation of the components of the HVAC&R system 10. For example, one or more control transfer devices (e.g., communication devices, data transfer devices), such as wires, cables, wireless communication devices, and the like, may communicatively couple the compressor 32, the expansion device 36, the pump 124 (e.g., control valve), the valves 116, 152, 174, 188, the float system 200, and/or any other suitable components of the HVAC&R system 10 to the controller 202. That is, the compressor 32, the expansion device 36, the pump 124, the valves 116, 152, 174, 188, and/or the float system 200 may each have a communication component that facilitates wired or wireless (e.g., via a network) communication with the controller 202. In some embodiments, the communication components may include a network interface that enables the components of the HVAC&R system 10 to communicate via various protocols such as EtherNet/IP, ControlNet, DeviceNet, or any other communication network protocol. Alternatively, the communication component may enable the components of the HVAC&R system 10 to communicate via mobile telecommunications technology, Bluetooth®, near-field communications technology, and the like. As such, the compressor 32, the expansion device 36, the pump 124, the valves 116, 152, 174, 188, and/or the float system 200 may wirelessly communicate data between each other.

In some embodiments, the controller 202 may include a portion or all of the control panel 82 or may be another suitable controller included in the HVAC&R system 10. In any case, the controller 202 may be configured to control components of the HVAC&R system 10 in accordance with the techniques discussed herein. The controller 202 includes processing circuitry 204, such as one or more microprocessors, which may execute software for controlling the components of the HVAC&R system 10. The processing circuitry 204 may include multiple microprocessors, one or more “general-purpose” microprocessors, one or more special-purpose microprocessors, and/or one or more application specific integrated circuits (ASICS), or some combination thereof. For example, the processing circuitry 204 may include one or more reduced instruction set (RISC) processors.

The controller 202 may also include a memory device 206 (e.g., a memory) that may store information such as instructions, control software, look up tables, configuration data, etc. The memory device 206 may include a volatile memory, such as random-access memory (RAM), and/or a nonvolatile memory, such as read-only memory (ROM). The memory device 206 may store a variety of information and may be used for various purposes. For example, the memory device 206 may store processor-executable instructions including firmware or software for the processing circuitry 204 execute, such as instructions for controlling components of the HVAC&R system 10. In some embodiments, the memory device 206 is a tangible, non-transitory, machine-readable-medium that may store machine-readable instructions for the processing circuitry 204 to execute. The memory device 206 may include ROM, flash memory, a hard drive, or any other suitable optical, magnetic, or solid-state storage medium, or a combination thereof. The memory device 206 may store data, instructions, and any other suitable data.

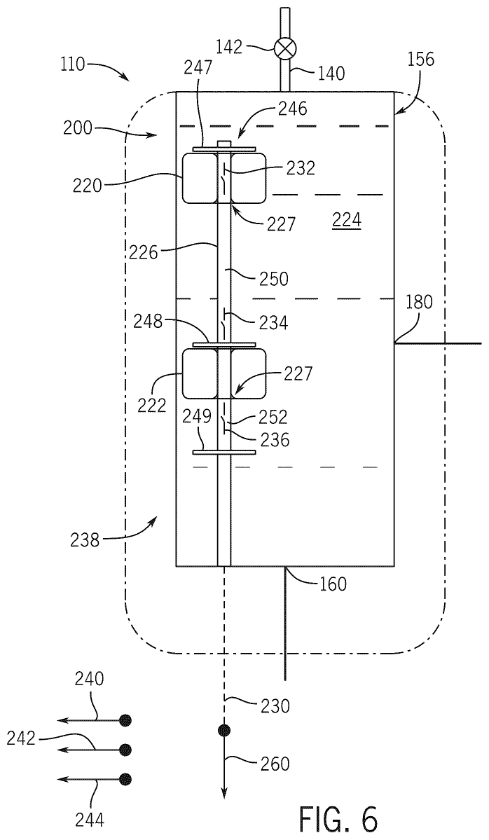

FIG. 6 is a schematic of an embodiment of a portion of the purge tank 110, illustrating the collection basin 156 and the float system 200. In the illustrated embodiment, the float system 200 includes a first float 220 and a second float 222. The first float 220 may have a density or weight that is less than a density or weight of the second float 222. In particular, a density of the first float 220 may be less than a density of heat transfer fluid 224 that may be in the collection basin 156 and less than a density of the condensable fluid 108 (e.g., water) that may be in the collection basin 156. A density of the second float 222 may be less than the density of the heat transfer fluid 224 and greater than the density of the condensable fluid 108. Accordingly, the first float 220 may float on (e.g., be suspended by) both the heat transfer fluid 224 and the condensable fluid 108, whereas the second float 222 may float on (e.g., be suspended by) the heat transfer fluid 224 but sink in (e.g., not be suspended by) the condensable fluid 108. For clarity, it should be understood that both the first float 220 and the second float 222 may not be suspended by (e.g., may sink in) the non-condensable gases 106.

In other embodiments, the first and second floats 220, 222 may be constructed in any other suitable manner to achieve the flotation characteristics discussed above. For example, in some embodiments, the first float 220 and the second float 222 may be made from the same type of material (e.g., materials having substantially similar densities). An additional piece of material (e.g., a weight ring) may be coupled to the second float 222 to increase a mass of the second float 222 relative to the first float 220. In this way, the first float 220 may float on (e.g., be suspended by) both the heat transfer fluid 224 and the condensable fluid 108, whereas the second float 222 (e.g., having the weight ring) may float on (e.g., be suspended by) the heat transfer fluid 224 but sink in (e.g., not be suspended by) the condensable fluid 108.

In the illustrated embodiment, the float system 200 includes a shaft 226 that may be configured to guide movement of the first and second floats 220, 222 along an axis 230 (e.g., a vertical axis, relative to gravity) of the shaft 226. For example, in certain embodiments, the shaft 226 may extend through corresponding openings (e.g., apertures 227) formed in the first and second floats 220, 222 to enable movement of the first and second floats 220, 222 along the axis 230 while blocking movement of the first and second floats 220, 222 in directions extending cross-wise to the axis 230. In other embodiments, the float system 200 may include any other suitable mechanism, device, or structure that is configured to guide movement of the first and second floats 220, 222 within the collection basin 156 in addition to, or in lieu of, the shaft 226.

In any case, the float system 200 may include a first switch 232, a second switch 234, and a third switch 236 (collectively switches 238) that may be engageable (e.g., transitioned between open and closed configurations) by the first and second floats 220, 222. For example, in some embodiments, the switches 238 may include reed switches that are actuatable via respective magnets disposed within and/or otherwise coupled to the first and second floats 220, 222. That is, the switches 238 may be actuated (e.g., closed) when a corresponding float 220 or 222 is within a threshold distance of a respective switch 238 that is sufficient to cause the magnet within the float 220 or 222 to engage (e.g., close) the switch 238.

In some embodiments, one or more limit plates 246 may be disposed along the shaft 226 and provide physical barriers that restrict movement of the first and second floats 220, 222 along particular sections of the shaft 226. For example, a first limit plate 247 and a second limit plate 248 may restrict movement of the first float 220 along a first section 250 of the shaft 226, while the second limit plate 248 and a third limit plate 249 may restrict movement of the second float 222 along a second section 252 of the shaft 226. In some embodiments, the limit plates 246 may be positioned along the shaft 226 such that the first float 220 may engage the first switch 232 and the second switch 234, but not the third switch 236. Further, the limit plates 246 may be positioned along the shaft 226 such that the second float 222 may engage the third switch 236, but not the first switch 232 or the second switch 234.

For example, the first float 220 may be configured to engage the first switch 232 when the first float 220 is a threshold distance from the first switch 232 (e.g., when the first float 220 reaches or contacts the first limit plate 247). The first float 220 may be configured to engage the second switch 234 when the first float 220 is a threshold distance from the second switch 234 (e.g., when the first float 220 reaches or contacts the second limit plate 248). The second float 222 may be configured to engage the third switch 236 when the second float 222 is a threshold distance from the third switch 236 (e.g., when the second float 222 reaches or contacts the third limit plate 249). In certain embodiments, the second limit plate 248 may be positioned such that, even when the second float 222 contacts the second limit plate 248, the second float 222 does not engage (e.g., close) the second switch 234. In some embodiments, the switches 238 may include any other suitable switches configured to enable operation of the float system 200 in accordance with the techniques discussed herein in addition to, or in lieu of, reed switches. In certain embodiments, one or more of the switches 238 may be coupled to and/or disposed within the shaft 226.

The switches 238 may each be communicatively coupled to the controller 202. In particular, the first float 220 may be configured to engage (e.g., activate) the first and second switches 232, 234, and the second float 222 may be configured to engage (e.g., active) the third switch 236. That is, the first switch 232 may send a first signal 240 to the controller 202 upon engagement with the first float 220, the second switch 234 may send a second signal 242 to the controller 202 upon engagement with the first float 220, and the third switch 236 may send a third signal 244 to the controller 202 upon engagement with the second float 222. As used herein, engagement of any of the floats 220, 222 with any of the switches 238 may refer to the floats 220 or 222 coming within a threshold distance of the corresponding one of the switches 238.

In some embodiments, the controller 202 may utilize feedback (e.g., data) from the switches 238 to determine an amount of the heat transfer fluid 224 within the collection basin 156, to determine an amount of condensable fluid 108 within the collection basin 156, or both. The controller 202 may, based on the received feedback, operate the purge system 100 (e.g., the control valve system 198 of the purge system 100) to selectively discharge heat transfer fluid 224 from the collection basin 156, to selectively discharge condensable fluid 108 from the collection basin 156, or both. Moreover, as discussed above, the controller 202 may operate the first outlet valve 142 of the control valve system 198 (e.g., based on sensor feedback and/or control instructions) to selectively discharge the non-condensable gases 106 from the purge tank 110 to the ambient environment (e.g., via the first outlet port 140). As such, it should be understood that the controller 202 may, based on sensor feedback and/or control instructions, adjust the control valve system 198 to selectively discharge the heat transfer fluid from the purge tank 110, adjust the control valve system 198 to selectively discharge the non-condensable gases 106 from the purge tank 110, adjust the control valve system 198 to selectively discharge the condensable fluid 108 from the purge tank 110, or a combination thereof.

For example, in the illustrated embodiment of FIG. 6, the collection basin 156 may include a quantity of heat transfer fluid 224 that is sufficient to cause the first float 220 to engage (e.g., close) the first switch 232. As such, the first switch 232 may transmit the first signal 240 to the controller 202, while the second switch 234 and the third switch 236 do not transmit corresponding signals 242, 244 to the controller 202. Upon receiving the first signal 240 from the first switch 232, and absent detection of respective signals from the second switch 234 and the third switch 236, the controller 202 may determine that a quantity of heat transfer fluid 224 within the collection basin 156 is relatively high and/or that draining heat transfer fluid from the collection basin 156 is desirable. That is, upon receiving the first signal 240 from the first switch 232, and absent detection of respective signals from the second switch 234 and the third switch 236, the controller 202 may determine that an amount of the heat transfer fluid within the purge tank 110 meets or exceeds an upper threshold level. As such, the controller 202 may initiate a heat transfer fluid draining procedure to drain heat transfer fluid 224 from the collection basin 156. To initiate the heat transfer fluid draining procedure, the controller 202 may instruct the second outlet valve 174 to transition to an open or partially open position. In this way, heat transfer fluid 224 may flow from the collection basin 156, through the third flow path 162, and to the evaporator 38.

In some embodiments, the controller 202 may instruct the first control valve 116 to open (e.g. at least partially) to allow pressurized gas (e.g., heat transfer fluid) from the condenser 34 to enter the purge tank 110 during the heat transfer fluid draining procedure, such that the pressurized gas may force the heat transfer fluid into and through the third flow path 162. The controller 202 may (e.g., via control of the first control valve 116) adjust a rate at which the heat transfer fluid is discharged from the purge tank 110 to be relatively low to inhibit remixing (e.g., swirling) of stratified heat transfer fluid and condensable fluid 108 in the purge tank 110. In some embodiments, such as when the compressor 32 of the vapor compression system 14 is idle, the controller 202 may activate the heating element 144 to increase a pressure within the purge tank 110 to effectuate flow of heat transfer fluid into the third flow path 162.

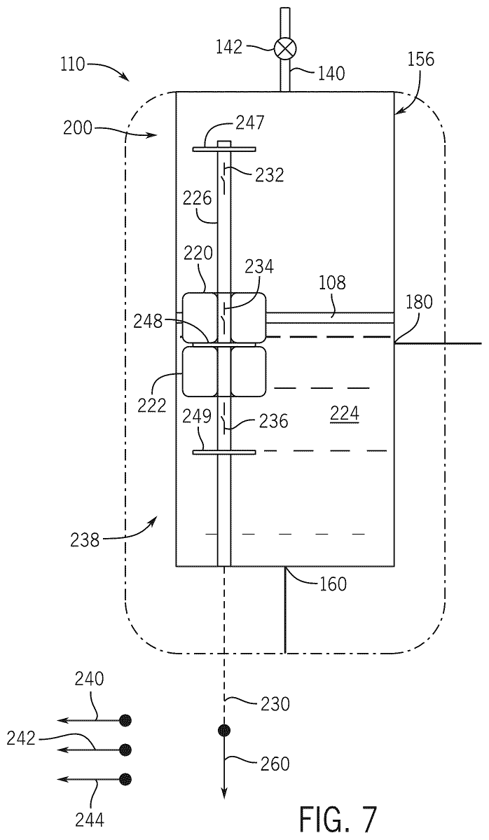

Execution of the heat transfer fluid draining procedure may cause a level of heat transfer fluid 224 in the collection basin 156 to decrease over time. Accordingly, the first float 220 may gradually move along the axis 230 in a first direction 260 (e.g., a direction along the direction of gravity) until the first float 220 engages (e.g., closes) the second switch 234. For example, to better illustrate the engagement between the first float 220 and the second switch 234, FIG. 7 is a schematic of an embodiment of a portion of the purge tank 110, in which the first float 220 is engaged with the second switch 234. In the illustrated embodiment of FIG. 7, the collection basin 156 may include a quantity of heat transfer fluid 224 that is sufficient to cause the first float 220 to move away from the first switch 232 (e.g., to disengage or open the first switch 232) and to move toward and engage the second switch 234. As such, the second switch 234 may transmit the second signal 242 to the controller 202, while the first switch 232 and the third switch 236 do not transmit corresponding signals 240, 244 to the controller 202. Upon receiving the second signal 242 from the second switch 234, and absent detection of respective signals from the first switch 232 and the third switch 236, the controller 202 may determine that a quantity of the heat transfer fluid 224 within the collection basin 156 is moderate and/or that further draining of heat transfer fluid from the collection basin 156 is desirable. That is, upon receiving the second signal 242 from the second switch 234, and absent detection of respective signals from the first switch 232 and the third switch 236, the controller 202 may determine that a quantity of the heat transfer fluid 224 within the purge tank 110 reaches an intermediate threshold level. Thus, the controller 202 may continue to execute the heat transfer fluid draining procedure to drain additional heat transfer fluid 224 from the collection basin 156.

In some embodiments, the controller 202 may continue to execute the heat transfer fluid draining procedure until receipt of the third signal 244 from the third switch 236, which may indicate that a heat transfer fluid level within the collection basin 156 has sufficiently dropped to enable the second float 222 to engage the third switch 236 (e.g., indicating that a quantity of heat transfer fluid in the purge tank 110 reaches a lower threshold level). That is, the controller 202 may continue to execute the heat transfer fluid draining procedure until the controller 202 receives the second signal 242 indicating that the first float 220 has engaged (e.g., closed) the second switch 234 and receives the third signal 244 indicating that the second float 222 has engaged (e.g., closed) the third switch 236. To suspend the heat transfer fluid draining procedure (e.g., upon receipt of the second signal 242 and the third signal 244), the controller 202 may instruct the second outlet valve 174 to transition to a closed positioned to block egress of heat transfer fluid 224 from the collection basin 156.

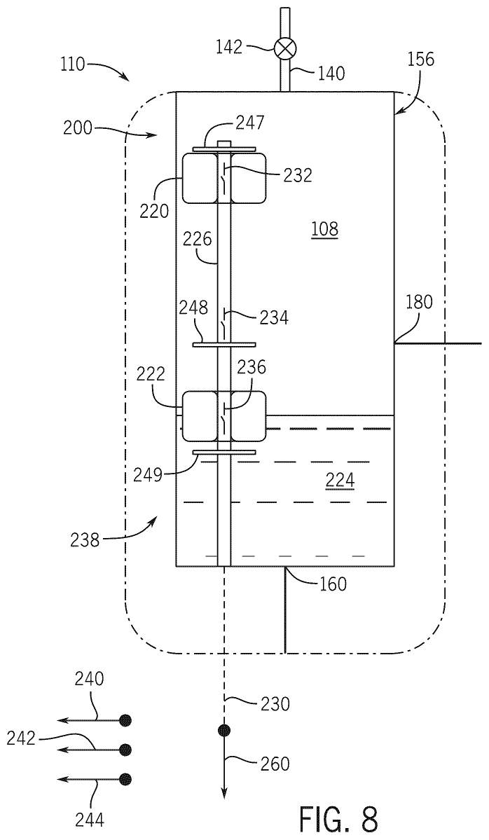

FIG. 8 is a schematic of an embodiment of a portion of the purge tank 110, illustrating condensable fluid 108 within the collection basin 156. As discussed above, in response to receiving the first signal 240, and absent detection of the second signal 242 and the third signal 244, the controller 202 may initiate the heat transfer fluid draining procedure to extract heat transfer fluid 224 from the collection basin 156. In cases where the collection basin 156 includes a significant quantity of condensable fluid 108, execution of the heat transfer fluid draining procedure may cause the second float 222 to move toward and engage with the third switch 236 while the first float 220 remains engaged with the first switch 232. Accordingly, the controller 202 may receive the first signal 240 from the first switch 232 and the third signal 244 from the third switch 236. In response to receiving the first signal 240 and the third signal 244, the controller 202 may determine that a quantity of heat transfer fluid 224 in the collection basin 156 is relatively low, while a quantity of condensable fluid 108 in the collection basin 156 is relatively high (e.g., indicating that draining of the condensable fluid 108 is desirable or warranted). That is, in response to receiving the first signal 240 and the third signal 244, the controller 202 may determine that a quantity of heat transfer fluid 224 in the purge tank 110 meets or is below a lower threshold level, while a quantity of condensable fluid 108 in the purge tank 110 meets or exceeds an upper threshold level. Accordingly, the controller 202 may suspend execution of the heat transfer fluid draining procedure (e.g., close the second outlet valve 174) and may initiate a condensable fluid draining procedure.

To initiate the condensable fluid draining procedure, the controller 202 may instruct the third outlet valve 188 to transition to an open position or a partially open position to enable egress of condensable fluid 108 from the collection basin 156 to the environment 178. That is, by instructing the third outlet valve 188 to transition to an open or partially open position, the controller 202 may enable flow of condensable fluid 108 from the collection basin 156, through the fourth flow path 182, and to the environment 178. In some embodiments, the controller 202 may instruct the first control valve 116 to open (e.g., at least partially open) to allow pressurized gas (e.g., heat transfer fluid) from the condenser 34 to enter the purge tank 110 during the condensable fluid draining procedure, such that the pressurized gas may force the condensable fluid 108 into and through the fourth flow path 182. The controller 202 may (e.g., via control of the first control valve 116) adjust a rate at which the condensable fluid 108 is discharged from the purge tank 110 to be relatively low to inhibit remixing (e.g., swirling) of stratified heat transfer fluid and condensable fluid 108 in the purge tank 110. In some embodiments, such as when the compressor 32 of the vapor compression system 14 is idle, the controller 202 may activate the heating element 144 to increase a pressure within the purge tank 110 to effectuate flow of condensable fluid 108 into the fourth flow path 182. In some cases, the controller 202 may maintain a pressure within the purge tank 110 to be slightly greater than atmospheric pressure during the condensable fluid draining procedure to inhibit backflow of air from the ambient environment into the purge tank 110. Execution of the condensable fluid draining procedure may cause the first float 220 to move toward and engage with (e.g., close) the second switch 234 (e.g., while the second float 222 remains engaged with the third switch 236).

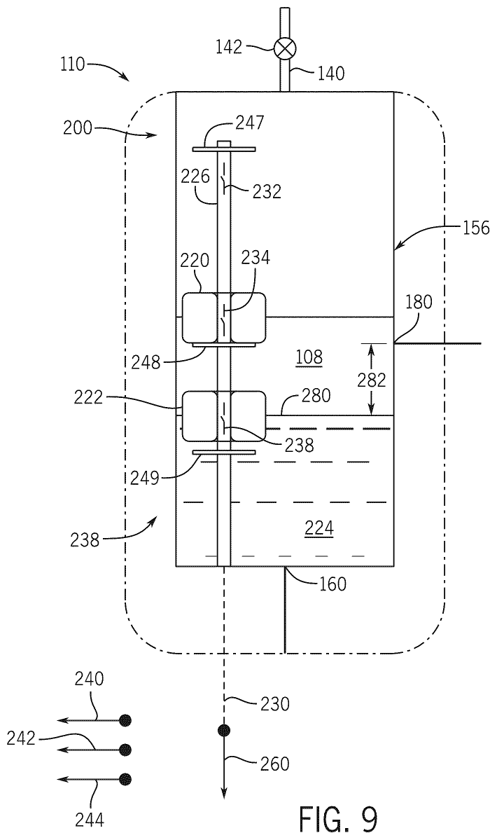

For example, to better illustrate the engagement between the first float 220 and the second switch 234, FIG. 9 is a schematic of an embodiment of a portion of the collection basin 156, in which a level of the condensable fluid 108 is relatively low. In response to receiving the second signal 242 and the third signal 244, the controller 202 may determine that a quantity of the condensable fluid 108 in the collection basin 156 and a quantity of the heat transfer fluid 224 in the collection basin 156 are each relatively low and/or that draining of heat transfer fluid and condensable fluid 108 is not desirable or warranted. That is, in response to receiving the second signal 242 and the third signal 244, the controller 202 may determine that a quantity of the condensable fluid 108 in the purge tank 110 reaches an intermediate threshold level (e.g., near the second limit plate 248), and a quantity of the heat transfer fluid in the purge tank 110 reaches a lower threshold level (e.g., near the third limit plate 249). Accordingly, the controller 202 suspend execution of the condensable fluid draining procedure (e.g., via transmission of instructions to close the third outlet valve 188) to block further egress of condensable fluid 108 from the collection basin 156. In some embodiments, it may be desirable to retain a residual amount of condensable fluid 108 in the collection basin 156 to inhibit flow of heat transfer fluid 224 through the third outlet port 180. As such, the second switch 234 and/or the second limit plate 248 may be positioned such that, when the first float 222 engages the second switch 234 (e.g., and the second float 222 engages the third switch 236), the third outlet port 180 is positioned above (e.g., with respect to a direction of gravity) an upper level 280 of the heat transfer fluid 224 within the collection basin 156 by a distance 282 (e.g., a target distance).

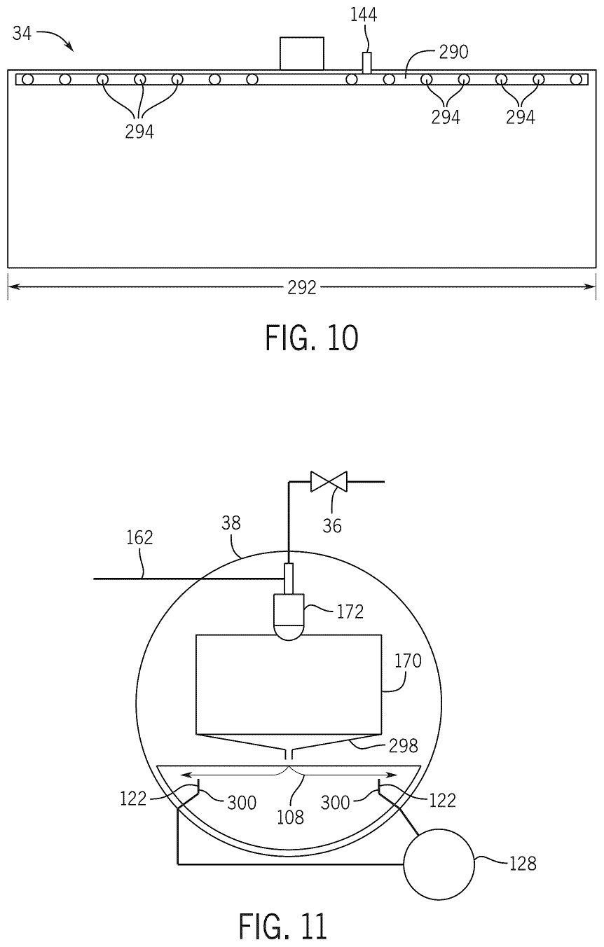

FIG. 10 is a cross-sectional schematic side view of an embodiment of the condenser 34. In some embodiments, the first port 114 may include a collection conduit 290 that may extend along at least a portion of a length 292 of the condenser 34. The collection conduit 290 may include a plurality of apertures 294 formed therein. The apertures 294 are configured to enable flow of heat transfer fluid 224 and non-condensable gases 106 into the collection conduit 290 and toward the first port 114. In this manner, the collection conduit 290 may facilitate more even extraction of fluid along the length 292 of the condenser 34.

FIG. 11 is a cross-sectional schematic axial view of an embodiment of the evaporator 38. In some embodiments, the second port 122 may be fluidly coupled to a liquid funnel 298 (e.g., guide) and liquid collectors 300 that may be disposed within an interior of the evaporator 38. The liquid funnel 298 and the liquid collectors 300 may be configured (e.g., shaped, oriented) to guide flow of liquid (e.g., the condensable fluid 108) toward and into the second port 122. As such, the liquid funnel 298 and the liquid collectors 300 may cooperate to facilitate collection of the condensable fluid 108 that may be in the evaporator 28 and to facilitate transfer of the condensable fluid 108 to the purge tank 110.

As set forth above, embodiments of the present disclosure may provide one or more technical effects useful for removal (e.g., purging) of non-condensable gases and condensable fluid from a vapor compression system via a purge system. As such, the purge system may improve a purity of heat transfer fluid within the vapor compression system and thereby enhance an overall operational efficiency of the HVAC&R system. Moreover, the purge system may improve a reliability of the HVAC&R system (e.g., reduce wear of electrical motor components due to exposure to water) and may reduce or substantially eliminate corrosion inside components (e.g., valves, conduits, pumps) of system. The technical effects and technical problems in the specification are examples and are not limiting. It should be noted that the embodiments described in the specification may have other technical effects and can solve other technical problems.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

It is important to note that the construction and arrangement of the purge system as shown in the various exemplary embodiments is illustrative only. Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A purge system for a heating, ventilation, air conditioning, and refrigeration (HVAC&R) system, comprising:
a purge tank configured to receive a fluid mixture from a vapor compression system, wherein the fluid mixture comprises heat transfer fluid, non-condensable gases, and condensable fluid;
a valve system fluidly coupled to the purge tank; and
a controller communicatively coupled to the valve system, wherein the controller is configured to adjust the valve system based on feedback to selectively discharge the heat transfer fluid from the purge tank, to selectively discharge the non-condensable gases from the purge tank, and to selectively discharge the condensable fluid from the purge tank.

2. The purge system of claim 1, comprising a float system disposed within the purge tank and configured to provide at least a portion of the feedback.

3. The purge system of claim 2, wherein the float system comprises:
a plurality of switches communicatively coupled to the controller; and
a plurality of floats configured to selectively engage one or more switches of the plurality of switches to generate one or more signals, wherein the controller is configured to analyze the one or more signals to determine a first amount of the condensable fluid within the purge tank, to determine a second amount of the heat transfer fluid within the purge tank, or both.

4. The purge system of claim 3, wherein, in response to a determination that the first amount of the condensable fluid within the purge tank reaches an upper threshold level and the second amount of the heat transfer fluid within the purge tank is below a lower threshold level, the controller is configured to operate the valve system in accordance with a condensable fluid draining procedure to drain the condensable fluid from the purge tank.

5. The purge system of claim 4, wherein, in response to a determination that the first amount of the condensable fluid within the purge tank decreases to an intermediate threshold level less than the upper threshold level, the controller is configured to suspend the condensable fluid draining procedure to block flow of the condensable fluid from the purge tank.

6. The purge system of claim 3, wherein, in response to a determination that the second amount of the heat transfer fluid within the purge tank reaches an upper threshold level, the controller is configured to operate the valve system in accordance with a heat transfer fluid draining procedure to drain the heat transfer fluid from the purge tank.

7. The purge system of claim 6, wherein, in response to a determination that the second amount of the heat transfer fluid within the purge tank decreases to a lower threshold level, the controller is configured to suspend the heat transfer fluid draining procedure to block flow of the heat transfer fluid from the purge tank.

8. The purge system of claim 1, wherein the controller is configured to adjust the valve system to direct pressurized heat transfer fluid from a condenser into the purge tank to pressurize the purge tank to force the heat transfer fluid to flow from the purge tank to an evaporator.

9. The purge system of claim 1, wherein the purge tank comprises a purge coil disposed therein, wherein the purge coil is configured to absorb thermal energy from the heat transfer fluid in the purge tank, the non-condensable gases in the purge tank, the condensable fluid in the purge tank, or a combination thereof.

10. The purge system of claim 1, wherein:
the purge tank comprises a collection basin and an upper portion positioned vertically above the collection basin, with respect to a direction of gravity, wherein the upper portion comprises a first diameter and the collection basin comprises a second diameter less than the first diameter,
and the purge system comprises a float system disposed within the purge tank and configured to provide at least a portion of the feedback, wherein the float system is disposed within the collection basin.

11. A float system for a purge tank of a heating, ventilation, air conditioning, and refrigeration (HVAC&R) system, comprising:
a plurality of switches; and
a plurality of floats configured to move relative to the plurality of switches, wherein the plurality of switches and the plurality of floats are configured to be disposed within the purge tank, and wherein the plurality of floats is configured to selectively engage one or more switches of the plurality of switches based on a first amount of condensable fluid within the purge tank and a second amount of heat transfer fluid within the purge tank to generate one or more signals indicative of the first amount and the second amount.

12. The float system of claim 11, wherein the plurality of floats comprises a first float and a second float, wherein the first float is configured to be suspended within the purge tank by the heat transfer fluid and the condensable fluid, and the second float is configured to be suspended within the purge tank by the heat transfer fluid and to sink in the condensable fluid.

13. The float system of claim 11, wherein the float system comprises a shaft configured to extend through the plurality of floats and guide movement of the plurality of floats relative to the plurality of switches.

14. The float system of claim 13, wherein each float of the plurality of floats comprises an aperture formed therein, where the shaft is configured to extend though the aperture of each float to guide movement of the plurality of floats along an axis of the shaft and to block movement of the plurality of floats cross-wise to the axis.

15. The float system of claim 11, wherein each switch of the plurality of switches is configured to be actuated in response to a corresponding float of the plurality of floats being positioned within a threshold distance of the switch.

16. A purge system for a heating, ventilation, air conditioning, and refrigeration (HVAC&R) system, comprising:
a float system configured to be disposed within a purge tank, wherein the float system comprises:
a plurality of switches; and
a plurality of floats configured to selectively engage, based on a first amount of condensable fluid within the purge tank and a second amount of heat transfer fluid within the purge tank, one or more switches of the plurality of switches to generate one or more signals; and
a controller configured to receive the one or more signals and to analyze the one or more signals to determine the first amount of the condensable fluid within the purge tank, the second amount of the heat transfer fluid within the purge tank, or both.

17. The purge system of claim 16, comprising a valve system configured to control discharge of the condensable fluid and the heat transfer fluid from the purge tank, wherein the controller is communicatively coupled to the valve system and configured to adjust the valve system based on the one or more signals.

18. The purge system of claim 17, wherein the controller is configured to operate the valve system in accordance with a condensable fluid draining procedure to drain the condensable fluid from the purge tank in response to a determination that the first amount of the condensable fluid within the purge tank is at or above an upper threshold level.

19. The purge system of claim 17, wherein the controller is configured to operate the valve system in accordance with a heat transfer fluid draining procedure to drain the heat transfer fluid from the purge tank in response to a determination that the second amount of the heat transfer fluid within the purge tank is at or above an upper threshold level.

20. The purge system of claim 16, wherein the plurality of floats comprises:
a first float configured to float within the heat transfer fluid and within the condensable fluid; and
a second float configured to float within the heat transfer fluid and configured to sink within the condensable fluid.
